(19) United States
(12) Patent Application Publication
(10) Pub. No.: US 2011/0203929 A1
(43) Pub. Date: Aug. 25, 2011

(54) RECOVERY OF LITHIUM FROM AQUEOUS SOLUTIONS

(76) Inventors: David Buckley, Gastonia, NC (US); J. David Genders, Elma, NY (US); Dan Atherton, Lancaster, NY (US); Rainer Aul, Rodgau (DE)

(21) Appl. No.: 12/935,663

(22) PCT Filed: Nov. 12, 2009
(86) PCT No.: PCT/US09/06073

§ 371 Date: Nov. 15, 2010

Related U.S. Application Data
(60) Provisional application No. 61/199,495, filed on Nov. 17, 2008.

(51) Int. Cl. B01D 61/44; B01D 61/46

(52) U.S. Cl. 204/537; 204/631

(57) ABSTRACT

A method for recovering lithium as lithium hydroxide by feeding an aqueous stream containing lithium ions to a bipolar electrodialysis cell, wherein the cell forms a lithium hydroxide solution. An apparatus or system for practicing the method is also provided.

This application claims the benefit of U.S. Provisional Application Ser. No. 61/199,495 filed Nov. 17, 2008, hereby incorporated by reference in their entirety for all purposes.

### FIELD OF THE INVENTION

The present invention relates in part to the recovery of lithium from lithium-containing solutions, e.g., such as feed streams used in the manufacture of lithium ion batteries, as well as feed streams resulting from lithium extraction from ore based materials.

### BACKGROUND OF THE INVENTION

Lithium containing batteries have become preferred batteries in a wide variety of existing and proposed new applications due to their high energy density to weight ratio, as well as their relatively long useful life when compared to other types of batteries. Lithium ion batteries are used for numerous applications, e.g., cell phones, laptop computers, medical devices and implants such as cardiac pacemakers.

Lithium ion batteries are also becoming extremely useful energy-source options in the development of new automobiles, e.g., hybrid and electric vehicles, which are both environmentally friendly and “green” because of the reduced emissions and decrease reliance on hydrocarbon fuels. This is clearly an advantage, as use of these batteries eliminate or reduces the need for hydrocarbon fuels and the resultant green house gas emissions and other associated environmental damage attributed to the burning of fossil fuels in internal combustion engines. Again, the selection of lithium-ion batteries for use in vehicles is due in large part to the high energy density to weight ratio, reducing the weight of batteries compared to other batteries, and important factor in the manufacture of vehicles.

Lithium ion batteries are typically made of three primary components: 1) a carbon anode, 2) a separator, and 3) a lithium containing cathode material. Preferred lithium containing cathode materials include lithium and metal oxide materials such as lithium cobalt oxide, lithium nickel-cobalt oxide, lithium manganese oxide and lithium iron phosphate, but other lithium compounds may be used as well.

Lithium iron phosphate is a particularly preferred compound for use as a lithium containing cathode material, as it provides an improved safety profile, acceptable operating characteristics, and is less toxic when compared to the other mentioned cathode materials. This is especially true for relatively large battery sizes, such as would be used in electric vehicles. The improved safety characteristics come from the ability of the Lithium Iron Phosphate (also called LIP) to avoid the overheating that other lithium ion batteries have been prone to. This is especially important as the batteries get larger. At the same time the battery operating characteristics of the LIP batteries are equal to that of the other compounds that are in current use. Other lithium compounds offer the reduction in overheating tendencies, however at the expense of the operating characteristics. Lithium iron phosphate sulfates are similar to LIP and are also used in batteries.

Lithium iron phosphate can be prepared using a wet chemistry process using an aqueous feed stream containing lithium ions from a lithium source, e.g., lithium carbonate, lithium hydroxide monohydrate, lithium nitrate, etc. A typical reaction scheme is described by Yang et al., Journal of Power Sources 146 (2005) 539-543 proceeds as follows:

3LiNO₃+3Fe(NO₃)₂.nH₂O+3(NH₄)₂HPO₄→Fe₃(PO₄)₂.nH₂O Li₃ PO₄+6NH₃+9HNO₃ (I)

Fe₃(PO₄)₂.nH₂O+Li₃PO₄→3LiFePO₄+nH₂O (II)

Lithium iron phosphate can be prepared using a wet chemistry process using an aqueous feed stream containing lithium ions from a lithium source, e.g., lithium carbonate, lithium hydroxide monohydrate, lithium nitrate, etc. Lithium iron phosphate sulfates are prepared similarly but a source of sulfate is needed for production. For example, U.S. Pat. No. 5,910,382 to Goodenough et al. and U.S. Pat. No. 6,514,640 to Armand et al. each describe the aqueous preparation of lithium iron phosphates. Generally, due to process inefficiencies, these wet chemistry methods of producing lithium iron phosphate result in an aqueous stream that contains a significant amount of lithium ions, along with other impurities. The composition of a typical stream that results from wet chemical preparation of lithium iron phosphate is given below:

| | Range in PPM |
|---|---|
| Chemical Element | (unless otherwise noted) |
| Al | 2-10 |
| B | <3-3 |
| Ba | <1-1 |
| Ca | 3-5 |
| Cu | 1-3 |
| Fe | 1-1.5 |
| K | <10-10 |
| Li | 1.4-1.5% |
| Mg | <1-1 |
| Na | 20-25 |
| P | 40-60 |
| S | 3.4-3.5% |
| Si | 25-35 |
| Zn | <1-2 |
| Cd, Co, Cr, Mn, Mo, | <1-<2 |
| Ni, Pb, Sn, Sr, Ti, V | |

Since lithium is one of the primary and more valuable components of the lithium iron phosphate material, it would be desirable to recover any excess lithium to reuse in the wet chemistry manufacture of lithium iron phosphate, particularly if a relatively large excess of lithium is provided during the manufacturing process for producing the lithium iron phosphate product. A lithium recovery and purification processes from lithium battery waste material is known from Published PCT application WO 98/59385, but improved and alternative methods of lithium recovery are desired in the art.

### OBJECTS AND SUMMARY OF THE INVENTION

The present invention satisfies this objective and others utilizing a bipolar electrodialysis, which is also known as salt splitting technology to recover lithium from feed streams. The lithium is recovered as a lithium hydroxide solution which can be recycled into feed streams used to produce the lithium iron phosphate using a wet chemical process. A sulfuric acid solution also results from the process, which can be recovered and used in other processes or sold commercially. In preferred embodiments, any phosphate ion in the feed stream is reduced, or, more preferably, removed, prior to bipolar electrodialysis of the feed stream because it has been discovered that phosphate tends to foul the membranes, reducing the yield of lithium hydroxide or preventing formation of it altogether. Alternatively in the sulfuric acid reduction of lithium bearing ore, the resultant purified lithium sulfate stream can also be processed in this manner. This has the advantage of also producing a sulfuric acid stream, which if concentrated, may be used to offset the purchase cost of the required sulfuric acid.

Bipolar membrane electrodialysis utilizes separate chambers and membranes to produce the acid and base of the respective salt solution introduced. According to this process, ion exchange membranes separate ionic species in solution via an electrical field. The bipolar membrane dissociates water into positively charged hydrogen ions (H⁺, present in the form of H₃O⁺ (hydronium ions) in aqueous solution) and negatively charged hydroxyl anions (OH).

Bipolar membranes are typically formed from an anion-exchange layer and a cation-exchange layer, which are bound together. A water diffusion layer or interface is provided wherein the water from the outer aqueous salt solution diffuses.

Selectively permeable anion and cation membranes are further provided to direct the separation of the salt ions, e.g., the lithium and sulfate ions, as desired. Thus, there is typically a three membrane system used in bipolar membrane electrodialysis.

Membranes from commercially available sources, e.g., Astom's ACM, CMB, AAV and BP1 membranes or FumaTech FKB membranes may be used in combination of their resistance to back migration of undesired ion (either H+ or OH−), low electric resistivity and resistance to the potentially corrosive nature of the resultant acid and base solution. These membranes are positioned between electrodes, i.e., an anode and a cathode, and a direct current (DC) is applied across the electrodes.

Preferred cell manufacturers include Eurodia, and EUR20 and EUR40 are preferred.

A preferred arrangement using bipolar membrane technology for recovery of lithium as lithium hydroxide from a stream containing lithium sulfate is shown in FIG. 4. As shown in FIG. 4, “A” is an anion permeable membrane; “C” is a cation permeable membrane. “B” is a bipolar membrane. The anion membrane allows the negatively charge sulfate ion to pass but hinders passage of the positively charged lithium ion. Conversely, the cation membrane allows the positively charged lithium ion to cross but hinders passage of the negative sulfate ion. A pre-charged acid and base reservoir are shown in the middle, with resultant H+ on OH− ions combining with the evolved negatively charge sulfate ion and positively charge lithium ion. Thus, lithium hydroxide solution is produced which can be fed into the process stream for preparing the lithium iron phosphate. A sulfuric acid solution results on the cathode side.

A lithium sulfate solution of the type previously described is preferably pretreated to a relatively high pH, typically to a pH of from 10 and 11, by addition of a suitable base, preferably an alkali hydroxide. Hydroxides of Li, Na, K are particularly preferred. Adjusting the pH to this range allows for removal of impurities, as precipitates, especially phosphates that are likely to interfere with the electrochemical reactions in the electrodialysis apparatus. It is especially preferred to remove at least phosphate from the feed, as it has been discovered that this impurity in particular leads to fouling of the membrane, impairing the process. These precipitates are filtered from the solution prior to feeding into the bipolar electrodialysis cell. The solution may then be adjusted to a lower pH, for example to 1-4 pH, and preferably 2-3, preferably utilizing the resultant acid from the process, as required and then fed into the electrodialysis cell. As explained above, during this process, the lithium ions cross the cation membrane resulting in a lithium hydroxide stream and the sulfate crosses the anion membrane producing a sulfuric acid stream. (See FIG. 4).

The resultant LiOH and sulfuric acid streams are relatively weak streams in terms of molar content of the respective components. For example, testing showed average ranges as follows:

LiOH: 1.6-1.85 M H₂SO₄: 0.57-1.1 M

Another aspect of the invention relates to the purity of the lithium hydroxide product, as purified lithium hydroxide product is highly desirable.

It has been found that a reduction in the sulfuric acid product concentration of about 50% results in the sulfate concentration in the hydroxide solution dropping by a corresponding amount (from 430 ppm to 200 ppm). Additionally the current efficiency, relative to acid production increased by about 10% with the reduction in acid concentration.

The block diagram of the above-mentioned process is shown in FIG. 1.

More specifically with respect to FIG. 1, a feed stream containing lithium sulfate, preferably from the production of a lithium battery component, is purified by removing any solid impurities by adjusting the pH to about 10 to about 11 to precipitate any solid impurities from the stream. The resultant purified lithium sulfate feed stream is then subjected to bipolar dialysis, preferably after adjusting the pH to about 2-3.5 with sulfuric acid, with a suitable bipolar membrane that will allow for the separation of lithium from the stream, which will be recovered as lithium hydroxide. In a preferred embodiment, prior to subjecting the lithium sulfate feed stream to bipolar electrodialysis, to the purification step or perhaps during the purification step, any phosphate is removed by, e.g., adjusting the pH to remove phosphate salts or by using an appropriate ion exchange membrane to remove the phosphate from solution. Alternatively a lithium sulfate stream from the sulfuric acid ore extraction process, proper purified by practices known in the art, may be subjected to bipolar dialysis, preferably after adjusting the pH to about 2-3.5 with sulfuric acid, with a suitable bipolar membrane that will allow for the separation of lithium from the stream, which will be recovered as lithium hydroxide.

It is thought that the current inefficiencies, particularly as they relate to the cation membrane, result in high localized pHs adjacent to the membrane causing precipitates to form in the central feed compartment. This can also be seen external to the cell by deliberately raising the pH of the feed to 10 and allowing the precipitate to form. Table 1 shows the composition of the solids collected from a 10 L batch of the feed lithium sulfate solution that had been pH adjusted to 10, left overnight and filtered. A total of 3.02 g of solid were recovered. A portion of the solids (0.3035 g) were re-dissolved in 100 ml of 1M HCl for analysis by ICP2. As can be seen from the Table 1 below, the major impurities in the precipitate appear to be Fe, Cu, P, Si, Zn and Mn3.

TABLE 1
ICP Analysis of redissolved solids (mg/L)

| | |
|---|---|
| Al | 11 |
| Ca | 9.2 |
| Cu | 21.0 |
| Fe | 22.4 |
| Li | 391.0 |
| Mn | 58.4 |
| Ni | 1.2 |
| P | 351.0 |
| S | 231.0 |
| Si | 46.6 |
| Sr | 0.2 |
| Zn | 22.9 |

Bipolar dialysis of the lithium sulfate feed stream with a suitable bipolar membrane yields a lithium hydroxide solution and a sulfuric acid solution as shown on the right and left hand sides of FIG. 1, respectively.

The lithium hydroxide solution can be recovered, or, preferably, may be directly introduced into a process for preparing LiFePO₄ or other lithium-containing salts or products. Of course the lithium hydroxide may be recovered and used, e.g., as a base in suitable chemical reactions, or to adjust the pH of the initial feed stream to remove impurities such as phosphate.

The lithium hydroxide solution that is recovered my be concentrated as desired before use, or, if necessary, subjected to additional purification steps.

Turing now to the left hand side of FIG. 1, the sulfuric acid solution is recovered and sold or used as an acid in suitable chemical and industrial processes. Alternatively it can be concentrated and used to offset associated purchase costs of the sulfuric acid needed in the acid extraction of lithium from lithium bearing ores.

FIG. 2 shows an alternative embodiment of the present invention, in which both the lithium hydroxide and sulfuric acid streams are recovered and used in a process for the manufacture of lithium iron phosphate, which essentially makes the process a continuous process. Since the iron in the process is added in the form of an iron sulfate, the use of the recovered sulfuric acid stream to form iron sulfate is a possibility. This will depend on the purity requirements of the iron sulfate as well as concentration levels required. According to this method, however, an alternate iron source than iron sulfate could be utilized, with the sulfuric acid solution providing the sulfate source.

More specifically, in FIG. 2 a lithium sulfate feed stream is purified as described above by adjusting the pH to from 10 to 11 and the pH is then readjusted downward to from 2 to 3.5 before being subject to electrodialysis.

As with FIG. 1, the purified bipolar electrodialysis with a suitable membrane to form an aqueous sulfuric acid stream and an aqueous lithium hydroxide feed stream. In this embodiment, focus is on recovering both the sulfuric acid and lithium hydroxide feed streams and returning them for use in the production of a lithium product, especially lithium iron phosphate. Focusing now on the left side of FIG. 2, the aqueous sulfuric acid stream is converted to iron sulfate by addition of an iron source into the sulfuric acid solution. The source may be any suitable source, including metallic iron found in naturally occurring iron ore. iron sulfate is a preferred iron salt since the solution already contains sulfate ion. Addition of the iron yields an iron phosphate solution, which is then ultimately mixed with the lithium hydroxide solution recovered from the bipolar electrodialysis process, and a phosphate source, to yield lithium iron phosphate.

As shown on the right side of FIG. 2, the lithium hydroxide solution is preferably adjusted to the required level of lithium hydroxide by introduction of lithium hydroxide from another source, or by concentrating the recovered stream.

Another preferred embodiment is shown in FIG. 3. In this option, a lithium source other than lithium hydroxide, e.g., lithium carbonate is used in the process. In this embodiment, the sulfuric acid stream is reacted with lithium carbonate of a predetermined purity, to produce additional lithium sulfate solution that would then be added to the original recycle solution prior to feeding into the bipolar electrolysis cells. This process is shown at the left hand side of the flow diagram in FIG. 3. Thus, different lithium sources can be used to yield a lithium solution from which lithium hydroxide can be extracted. The pH adjustment steps of the LiSO₄ feed stream are as described above.

Note that iron sulfate is shown to be added to all or a portion of the sulfuric acid stream to yield an iron sulfate solution which is along with the recovered lithium hydroxide solution to produce lithium iron phosphate according to a wet chemical process such as described herein.

### BRIEF DESCRIPTION OF THE FIGURES

FIG. 1:

A block diagram of a simplified lithium sulfate bipolar electrodialysis recycle process for recycling lithium hydroxide lithium sulfate into a process of manufacturing lithium iron phosphate.

FIG. 2:

A block diagram of a lithium sulfate bipolar electrodialysis recycle process for recycling both lithium hydroxide and sulfuric acid into a process of manufacturing lithium iron phosphate.

FIG. 3:

A block diagram of a lithium sulfate bipolar electrodialysis recycle process for using recycled lithium hydroxide, sulfuric acid, and lithium hydroxide generated from an additional lithium source to manufacture lithium iron phosphate.

FIG. 4:

A schematic diagram of a bipolar electrodialysis cell used for recover of lithium as lithium hydroxide from a stream containing lithium sulfate.

FIG. 5:

A plot of current density as a function of time during the process of running pH 10 pre-treated feed solutions through an electrodialysis cell containing Astom membranes.

FIG. 6:

A plot of current density and concentrations of acid and base products as a function of time during the process of running pH 11 pre-treated feed solutions through an electrodialysis cell.

FIG. 7:

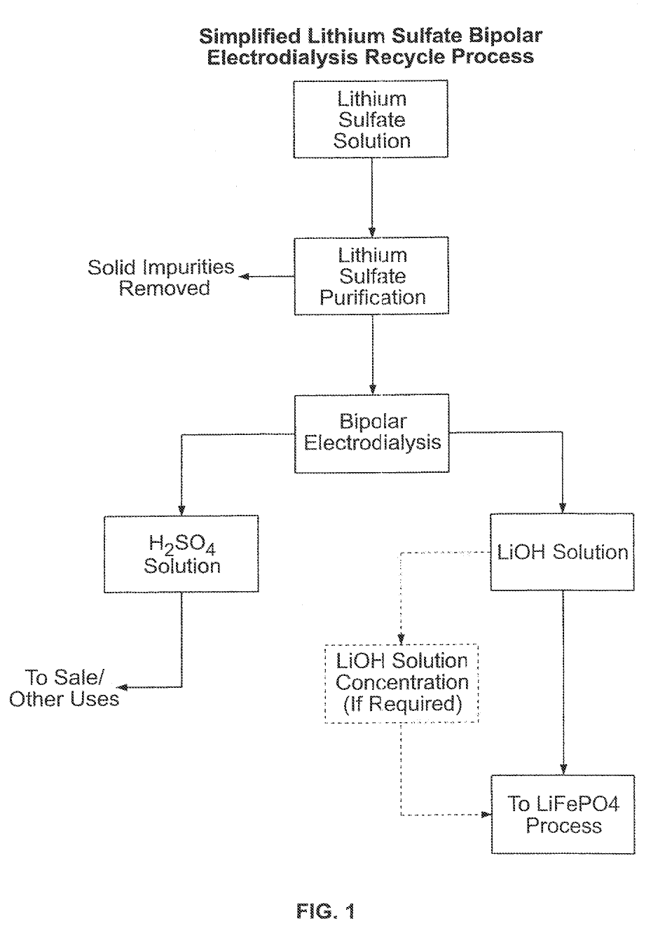

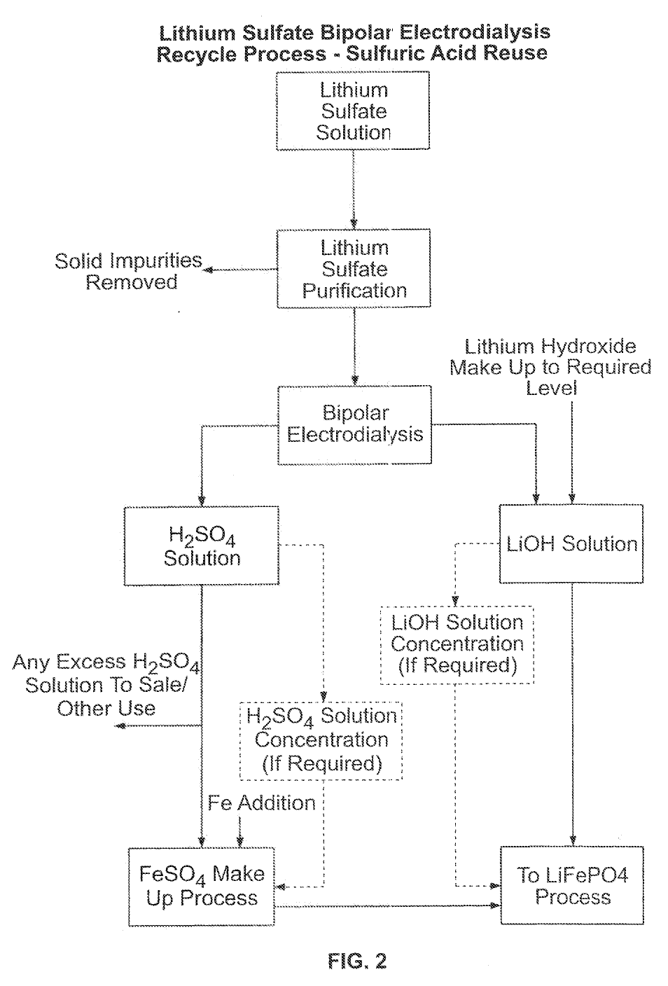

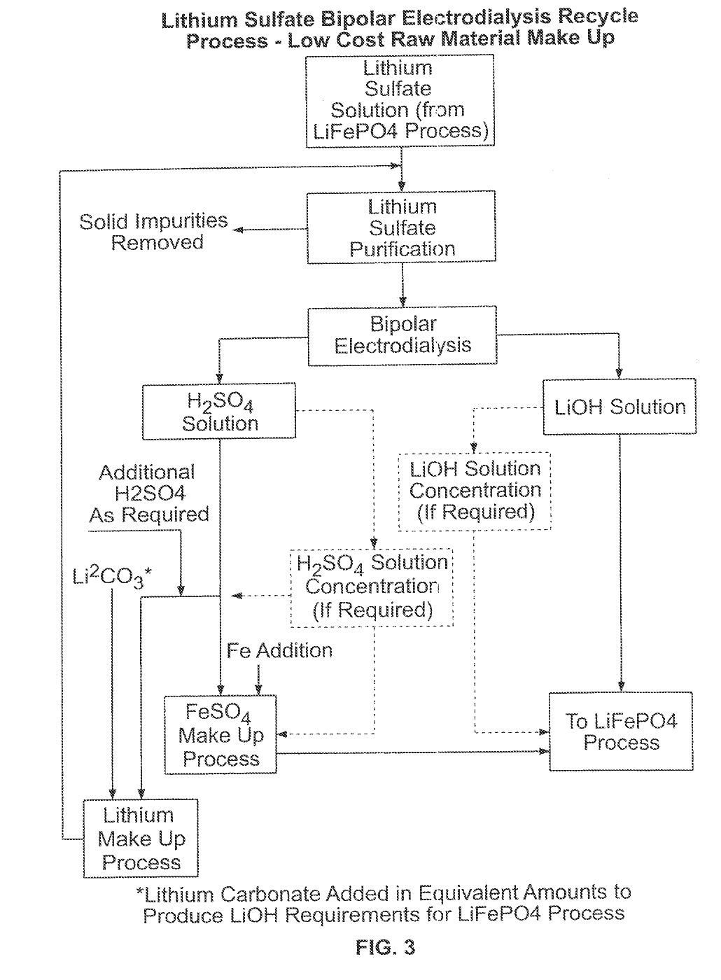

A plot of current density as a function of time during the process of running feed solutions through an Eurodia EUR-2C electrodialysis cell operating at a constant voltage.

### DESCRIPTION OF PREFERRED EMBODIMENTS

### Example 1

An EUR-2C electrodialysis cell commercially available from Euroduce was modified to include Astom bipolar membranes (BP1) and FuMaTech anion and cation membranes (FAB and FKB respectively). The cell was run with a feed solution that had been pre-treated by pH adjustment to10 to precipitate phosphate and other impurities followed by filtration to remove the precipitates. The pH was then adjusted to pH 3.5 before feeding it into the cell.

As can be seen from Table 2, the cation membrane generated up to 2.16M LiOH at current efficiencies of approximately 75%. The anion exchange membrane yielded current efficiencies of 40% for a 0.6M H₂SO₄ product solution. The average current density throughout the run was nearly almost 62 mA/cm² while operating the cell at a constant voltage of 25V. (This voltage is applied across all seven sets of membranes and the electrode rinse compartment). No solids were seen in the cell in this short term operation, indicating that the pretreatment adjustment of pH to 10 prior to introduction into the cell improved results compared to using the feed solution without pH adjustment.

The overall efficiency of the cell appears to be dictated by the lowest current efficiency of any particular membrane since we have to use one of the product streams was used to maintain the pH in the central compartment. So, in Example 1 it was necessary to add some of the product LiOH back into the central compartment to neutralize the back-migrating proton from the acid compartment. Hence the overall current efficiency for the cell would have been 40% negating the advantage of the FKB membrane.

### Example 2-5

Example 2 through 5 were all run with Astom membranes (ACM, CMB and BPD. Examples 2 and 3 were short term experiments using lithium sulfate feed solutions that had been pretreated to pH 10 as described previously. Both examples yielded acid and base current efficiencies close to 60% and maintained good current densities over the short term indicating that the pretreatment improved results compared to prior runs. Example 4 was an overnight experiment run with the same conditions and showed a marked drop in current density, probably due to membrane fouling with phosphate or other precipitates.

FIG. 5 shows the current density for all three runs. After 1250 minutes the cell was paused and the pumps turned off to allow sampling. Upon restarting the system the current density recovered dramatically indicating that the drop in current was due to small amounts of precipitate that were subsequently washed out of the cell.

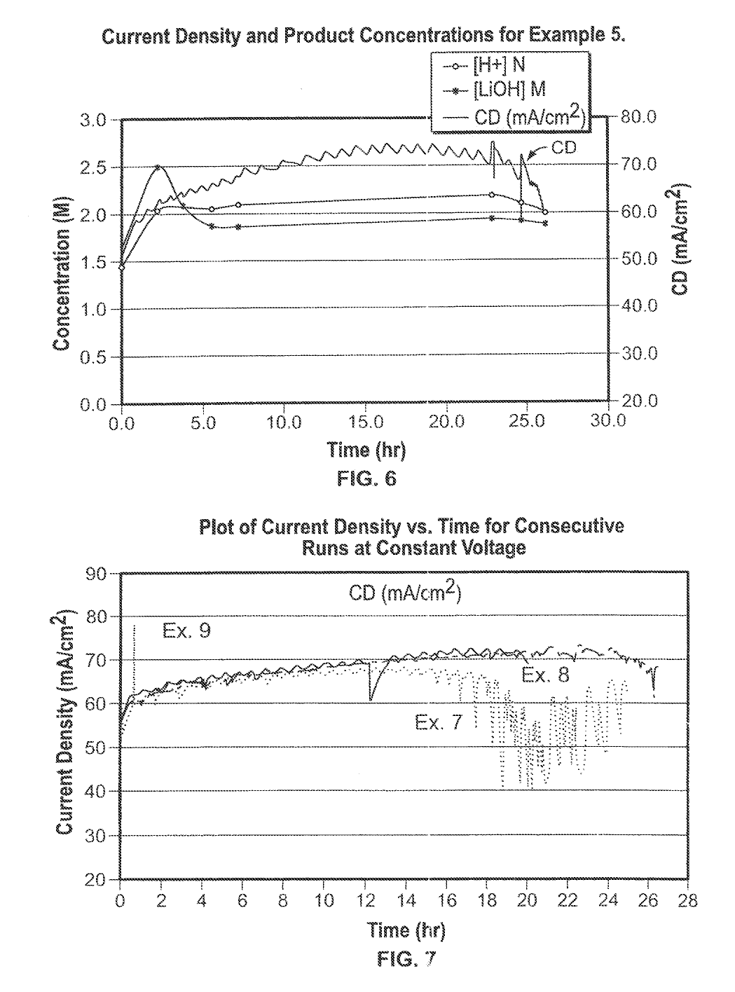

Since the pretreatment at pH 10 seemed to leave some foulant in the feed stream, Example 5 used a solution that had been pretreated to pH 11 for three days and was then filtered. As shown in FIG. 6, the current density being maintained for over 24 hours a clearly improved result. The final drop in current is thought to be due to the lithium sulfate in the feed becoming exhausted, as this was run as a single large batch.

FIG. 6 also shows that the acid and base concentrations were maintained fairly constant by constant water addition. Thus, it is desirable and sometimes necessary to add product acid or base to control the pH in the central feed compartment. To facilitate control of this compartment, a higher acid concentration was chosen to thereby lowering the acid current efficiency so that the pH in the central compartment could be controlled at 3.5 solely by the addition of LiOH. The average current efficiency for the hydroxide formation was almost 60%.

FIG. 6 shows the sulfate concentration in all three compartments as a function of time. The central compartment was run as a single batch and by the end of the experiment the concentration had reached about 0.2M. The sulfate in the LiOH was approximately 400 mg/L which accounts for approximately 0.85% of the current. Reducing the sulfuric acid concentration would reduce the sulfate content in the LiOH could be reduced further.

### Examples 6-10

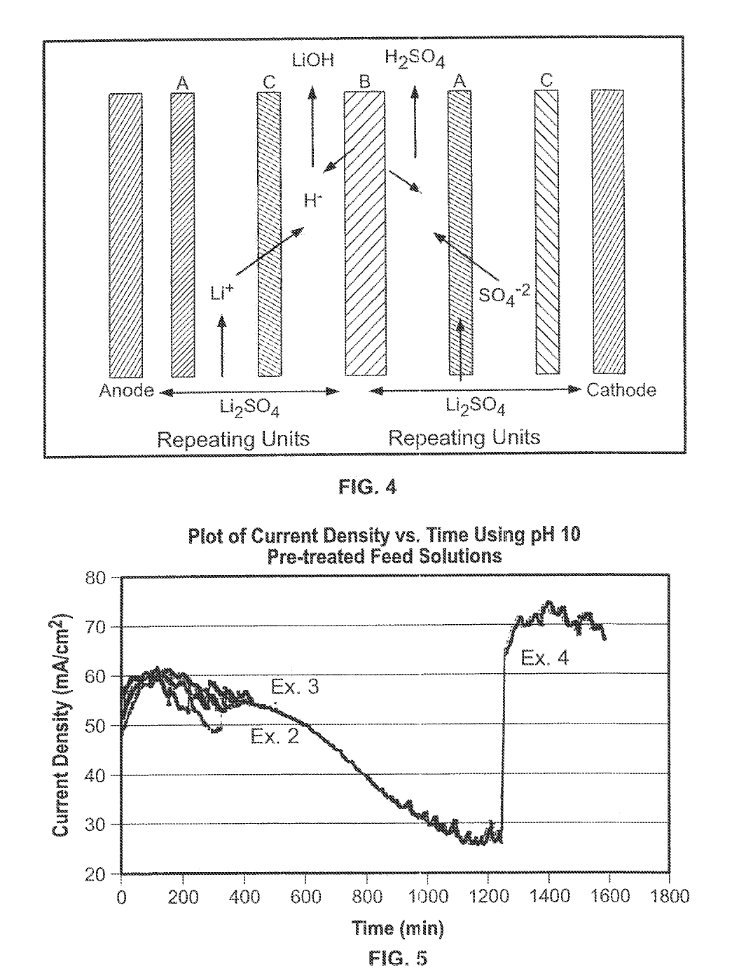

In Example 6-10 the Eurodia EUR-2C electrodialysis cell was used to demonstrate the feasibility of a three compartment salt splitting of lithium sulfate. The cell was assembled with seven sets of cation, anion and bipolar membranes configured as shown in FIG. 4. Each membrane has an active area of 0.02 m².

It is believed lithium phosphate which is formed in high pH regions adjacent to the cation membrane due to back migration of hydroxide ion is primarily responsible for membrane fouling when it occurs. Pretreatment of the feed solution to remove phosphate and other impurities by raising the pH to 11 precipitates most of these salts and yields improved results compared to adjustment to a pH of only 10.

Example 9 is representative and is described in detail below. A 1M lithium sulfate starting solution was pretreated to remove insoluble phosphate salts by raising the pH to 11 with 4M LiOH at a ratio of approximately 1L of LiOH to 60L of 1M Li₂SO₄. The treated lithium sulfate was mixed well and the precipitate was allowed to settle overnight before filtering through glass fiber filter paper (1 μm pore size). The filtered Li₂SO₄ pH was readjusted to 2 pH with the addition of approximately 12 mL of 4M sulfuric acid per liter of Li₂SO₄.

The starting volume of pretreated Li₂SO₄ feed was 8 L and was preheated to approximately 60° C. before transferring to a 20 L glass feed reservoir. The initial LiOH base was a heel of 3 liters from Example 8 which was analyzed at the start of the experiment at 1.8M LiOH. The initial acid was a heel of 2 L H₂SO₄ also from Example 8 and analyzed at 0.93M H₂SO₄. The electrode rinse was 2 liters of 50 mM sulfuric acid. The solutions were pumped through a Eurodia cell (EUR-2C-BP7) at approximately 0.5 L/minicompartment (3-4 L/min total flow) with equal back pressure maintained on each compartment (3-4 psi) to prevent excessive pressure on any one membrane which could lead to internal leaking. The flow rates and pressures of each were monitored along with feed temperature, feed pH, cell current, voltage, charge passed and feed volume.

The electrodialysis operated at a constant 25 volts. The Li₂SO₄ feed temperature was controlled at 35° C. The pumps (TE-MDK-MT3, Kynar March Pump) and ED cell provided sufficient heating to maintain the temperature. The 20 liter feed tank was jacketed so that cooling water could be pumped through the jacket via a solenoid valve and temperature controller (OMEGA CN76000) when the temperature exceeded 35° C.

The cell membranes provided sufficient for heat transfer to cool the other compartments. To run this experiment continuously for 20 hours, the Li₂SO₄ feed was replenished pumping in pretreated pH 2, 1M Li₂SO₄ feed at a continuous rate of 10 mL/minute. The proton back migration across the ACM membrane was greater than the hydroxide back migration across the FKB cation membrane, so the central compartment pH would normally drop. The pH of the central compartment was controlled by the addition of 4M LiOH using a high sodium pH of electrode and a JENCO pH/ORP controller set to pH 2. Electronic data logging of feed pH every minute over the 20 hour experiment showed a variation in pH of from 1.9 to 2.1, thus a total of 3.67 L of 4M LiOH was added to the feed to neutralize hydroxide back migrating. The feed volume increased from 8 L to 15.3 L after 20 hour of operation due to the addition of 11.8 L of Li₂SO₄ and 3.7 L LiOH, and 6.8 L of water transport to the acid and 0.7 L of water transport to the base.

The LiOH base was circulated through the cell from a 1 gallon closed polypropylene tank. The 3 liter volume was maintained by drawing off the top using tubing fixed at the surface of the LiOH and using a peristaltic pump to collect the LiOH product in a 15 gal overflow container. The concentration of the LiOH was maintained at 1.85M LiOH concentration by the addition water to the LiOH tank at a constant rate of 17 mL/minute.

The sulfuric acid was circulated through the acid compartment of the cell from a 2 L glass reservoir. An overflow port near the top of the reservoir maintained a constant volume of 2.2 L of H₂SO₄ over-flowing the acid product to a 15 gal tank. The concentration of the H₂SO₄ was held constant at 1.9M with the addition of water at a constant rate of 16 mL/minute.

The electrode rinse (50 mM H₂SO₄) was circulated through both the anolyte and catholyte end compartments and recombined at the outlet of the cell in the top of a 2 liter polypropylene tank where O₂ and H₂ gases produced at the electrodes were vented to the back of a fume hood.

Several samples were taken during the experiment to insure that the water addition rates to the acid and base were sufficient to hold the concentrations constant over the course of the experiment. At the end of the 19.9 hour experiment the power was turned off, the tanks were drained and the volumes of the final products were measured along with the final Li₂SO₄ and electrode rinse. The total LiOH made was 30.1 L of 1.86 M LiOH (including 3L heel), and 21.1 L of 1.92M H₂SO₄ (including 2 L heel). The final feed was 15.3 liters of 0.28M Li₂SO₄, and a final electrode rinse containing 1.5 L of 67 mM H₂SO₄. There was 0.5 L of water transport from the electrode rinse across the cation membrane to the acid. The total amount of water added was 18.6 liters to the acid and 20.4 liters to the base. The total charge passed was 975660 coulombs (70.78 moles) with 33.8 mole H back migration, 20.2 moles OH⁻ back migration, and 14.97 moles of LiOH added to the feed. The average current density for this experiment was 67.8 mA/cm². The H2SO4 current efficiency was 52.5% based on analysis of sulfate accumulation in the acid, and LiOH current efficiency was 72.4% based on the analysis of Li+ in the LiOH product.

The start and end samples were analyzed for SO₄²⁻ by using a Dionex DX600 equipped with an GP50 gradient pump, AS 17 analytical column, ASRS300 anion suppressor, a CD25 conductivity detector, EG40 KOH eluent generator and an AS40 autosampler. A 25 μL sample is injected onto the separator column where anions are eluted at 1.5 mL/min using a concentration gradient of 1 mM to 30 mM KOH with a 5 mM/min ramp. Sulfate concentration was determined by using the peak area generated from the conductivity detection verses a four point calibration curve ranging from 2 to 200 mg/L SO₄²⁻. Sample analysis for Li⁺ were done by a similar technique using a Dionex DX320 IC equipped with IC25A isocratic pump, CS 12a analytical column, CSRS300 cation suppressor, a IC25 conductivity detector, ECG II MSA eluent generator and an AS40 autosampler. A 25 μL sample was injected onto the separator column where anions are eluted at 1.0 mL/min using a concentration gradient of 20 mM to 30 mM methanesulfonic acid (MSA). Lithium concentration was determined by using the peak area generated from the conductivity detection versus a four point calibration curve ranging from 10 to 200 mg/L Li⁺ The H₂SO₄ acid concentration was determined by a pH titration with standardized 1.0N sodium hydroxide to pH 7. The base concentration was determined by titration with standardized 0.50N sulfuric acid to pH 7 using a microburrete.

Table 3 summarizes the results from electrodialysis experiments run with the Astom ACM membrane. Example 6 also used the Astom CMB and BPI cation and bipolar membrane respectively. The lithium sulfate feed solution was pre-treated to pH 11, filtered and then readjusted to pH 3.5 prior to running in the cell. The results are comparable to those reported last month in terms of current efficiency; however, the average current density is lower than previous runs indicating that we are still seeing some fouling. A pH gradient at the cation membrane at pH 3.5 appeared to be causing a precipitation issue, the pH of the feed compartment was reduced to a pH of 2 and FuMaTech FKB cation membrane, which has have less hydroxide back migration, was used. The pairing of the FI(13 and ACM membranes means that the pH in the central compartment is dominated by the back migration of proton across the ACM and pH control is accomplished solely by the addition of LiOH.

Example 7 to 9 are repeat runs with the FKB/ACM/BP1 combination giving a total of 70 hours of operation in three batches. It can be seen from Table 1 that the reproducibility of these runs is excellent with the current efficiency for LiOH measured three different ways at 71-75% (measured by Li+ loss from the feed, Li+ and hydroxide ion gain in the base compartment). Likewise the acid current efficiency is 50-52% by all three measurement methods. Data from these examples show consistency of the average current density. FIG. 7 shows this graphically where the initial current densities match each other very well. The deviations at the end of each batch are due to different batch sizes, and, therefore, different final lithium sulfate concentrations.

The high current efficiency of the FKB membrane appears to help avoid precipitation problems at the boundary layer on the feed side of the cation membrane. The overall current efficiency of the process is determined by the poorest performing membrane. That is, the inefficiency of the ACM membrane must be compensated for by the addition of LiOH from the base compartment back into the feed compartment thereby lowering the overall efficiency to that of the anion membrane. In an effort to increase the efficiency of the anion membrane, the acid concentration was reduced in the product acid compartment. Example 10 was run with 0.61 M sulfuric acid which has the effect of increasing the acid current efficiency by almost 10% to 62%. (See Table 3).

### Examples 11-12

In an effort to further increase the acid current efficiency, the cell was modified with an AAV alternate anion membrane from Astom in Examples 11 and 12. The AAV membrane is an acid blocker membrane formerly available from Ashahi Chemical. Table 4 shows a summary of the data from these experiments using a combination of FKB, AAV and the BP-1 bipolar membrane.

Current efficiencies for both acid and base from these membranes are very similar to the combination of Examples 7-9. There was about a 10% increase in the acid current efficiency when using a lower acid concentration. The average current density for this membrane combination is slightly lower than when the ACM membrane was used (approximately 10 mA/cm² for the same acid concentration and operating at a constant stack voltage of 25V). External AC impedance measurements confirmed that the resistance of the AAV is higher than the ACM when measured in Li₂SO₄ solution.

The purity of the lithium hydroxide product to be recycled into the process for making lithium iron phosphate is of great importance. The major impurity in the LiOH stream using this salt splitting technique will be sulfate ion that is transported across the bipolar membrane from the acid compartment into the base. The amount of transport should be directly related to the acid concentration. This can clearly be seen by comparing Example 9 with Example 10 (See Table 3) and Example 11 with Example 12 (Table 4). In each case the sulfate contamination in the 1.88M LiOH was approximately reduced by half when the acid concentration was reduced from 1M to 0.6M. The steady state sulfate concentrations are 430 and 200 ppm respectively.

As sulfate and lithium ions are transported across the ion exchange membranes, water is also transferred due to the hydration of the ions (electro-osmosis), and osmosis. However, the water transport out of the central compartment is not sufficient to keep the concentration constant. This is illustrated by considering the water transfer in Example 8. For every lithium ion that transferred across the cation membrane, 7 waters are also transferred. Similarly, an average 1.8 waters net were transferred with the sulfate ion giving a total of 15.8 waters for each lithium sulfate. Since the feed solution was only one molar in lithium sulfate, it contains almost 55 moles of water for each lithium sulfate which will lead to a continual dilution of the lithium sulfate in the central compartment. Removing water from the feed compartment can control this and can be done by, e.g., reverse osmosis for example.

All references cited herein are incorporated by reference in their entireties for all purposes.

1. A method for recovering lithium as lithium hydroxide comprising feeding an aqueous stream containing lithium ions to a bipolar electrodialysis cell, wherein the cell forms a lithium hydroxide solution.

2. The method of claim 1, comprising steps of
(a) feeding a lithium-containing stream into an apparatus containing a bipolar electrodialysis cell;
(b) electrodialyzing the lithium-containing solution to separate positively charged lithium ions and negatively charged ions;
(c) recovering lithium as a lithium hydroxide solution resulting from the electrodialysis separation step.

3. The method of claim 1, wherein the lithium hydroxide is fed to a process stream that requires said lithium hydroxide.

4. The method of claim 1, wherein the lithium hydroxide is fed to a lithium hydroxide requiring process that requires said lithium hydroxide so that said lithium hydroxide requiring process is continuous.

5. The method of claim 1, wherein said feed stream is used to produce lithium iron phosphate.

6. The method of claim 1, wherein said stream comprises lithium ions from a lithium source, selected from the group consisting of lithium carbonate, lithium hydroxide monohydrate, and lithium nitrate.

7. The method of claim 1, wherein said stream is resulted from lithium extraction from lithium bearing ores or lithium bearing ore based materials.

8. The method of claim 2, further comprising recycling lithium hydroxide recovered from the electrodialysis separation into a feed stream used in the process that requires said lithium hydroxide.

9. The method of claim 2, further comprising reducing or removing phosphate ion in the feed stream prior to bipolar electrodialysis.

10. A bipolar electrodialysis apparatus for separating ionic species in a lithium containing stream by using a bipolar electrodialysis cell, wherein said bipolar electrodialysis cell comprises
(a) an anion permeable membrane, allowing the negatively charged ion to pass but hindering passage of the positively charged lithium ion;
(b) a cation permeable membrane, allowing the positively charged lithium ion to pass but hindering passage of the negatively charged ion;
(c) a bipolar membrane located between an anion permeable membrane and a cation permeable membrane, forming separate chambers with the anion permeable membrane and the cation permeable membrane respectively;
(d) an anode and a cathode, with said anion permeable membrane, cation permeable membrane and bipolar membrane positioned between said anode and said cathode; and
(e) a direct current applied across the electrodes.

11. The bipolar membrane of claim 10, wherein said bipolar membrane is formed from an anion-exchange layer and a cation-exchange layer, with said layers bound together.

12. The bipolar membrane of claim 11, further comprising a water diffusion layer or interface, allowing the water from the outer aqueous salt solution to diffuse.

13. The membranes of claim 10 are from commercially available sources.

14. The membranes of claim 13 are from commercially available sources selected from the group consisting of Astom's ACM, CMB, AAV, BP, or FumaTech FKB.

15. The membranes of claim 10 are used in combination of their resistance to back migration of undesired ion, low electric resistivity and resistance to the potentially corrosive nature of the resultant acid and base solution.

16. The method of claim 1, wherein the feed stream contains lithium ions as lithium sulfate, comprising steps of
(a) feeding a lithium sulfate stream into an apparatus containing a bipolar electrodialysis cell;
(b) electrodialyzing the lithium sulfate stream to separate positively charged lithium ions and negatively charged sulfate ions;
(c) generating a lithium hydroxide solution at anode side and a sulfuric acid solution at the cathode side; and
(d) recovering lithium as a lithium hydroxide solution resulting from the bipolar electrodialysis.

17. The method of claim 16, wherein said lithium sulfate containing stream is a feed stream from the production of a lithium battery component.

18. The method of claim 16, further comprising steps of
(a) adjusting the lithium sulfate stream to a pH of from 10 and 11 to remove impurity by adding an alkali hydroxide;
(b) precipitating impurity from the lithium sulfate stream;
(c) filtering impurity from the lithium sulfate stream; and
(d) adjusting the pH of the resulting stream to a pH of from 1 to 4 prior to feeding said stream into the bipolar electrodialysis apparatus.

19. The method of claim 18, wherein said alkali hydroxide is selected from the group consisting of hydroxides of Li, Na, and K.

20. The method of claim 18, wherein the impurity is phosphate.

21. The method of claim 18, wherein the pH of the lithium sulfate stream of step (d) is adjusted to from 2 to 3.5.

22. The method of claim 18, wherein the pH of the lithium sulfate stream of step (d) is adjusted to from 2 to 3.

23. The method of claim 16, further comprising removing phosphate from the lithium sulfate stream by using an ion exchange membrane prior to feeding said stream into the bipolar electrodialysis apparatus.

24. The method of claim 16, wherein the lithium hydroxide solution is introduced into a process for preparing LiFePO₄ or other lithium-containing salts or products.

25. The method of claim 16, wherein said recovered lithium hydroxide is used as a base in chemical reactions.

26. The method of claim 16, wherein the lithium hydroxide solution is used to adjust the pH of a feed stream containing lithium sulfate.

27. The method of claim 16, further comprising concentrating the lithium hydroxide solution.

28. The method of claim 16, further comprising purifying the lithium hydroxide solution.

29. The method of claim 16, further comprising steps of
(a) recovering the sulfuric acid solution resulting from the bipolar electrodialysis;
(b) adding an iron source into the recovered sulfuric acid solution;
(c) converting said sulfuric acid solution into ion sulfate;
(d) mixing said ion sulfate, the recovered lithium hydroxide solution and a phosphate source to produce lithium ion phosphate, wherein said lithium phosphate is generated in a continuous process.

30. The method of claim 29, wherein said ion source is metallic iron found in naturally occurring iron ore.

31. The method of claim 29, wherein said recovered lithium hydroxide solution is adjusted to the required level of lithium hydroxide by introducing lithium hydroxide from another source.

32. The method of claim 29, wherein said recovered lithium hydroxide solution is adjusted to the required level of lithium hydroxide by concentrating recovered lithium hydroxide solution.

33. The method of claim 29, further comprising steps of
(a) adjusting the lithium sulfate stream to a pH of from 10 and 11 to remove impurities by adding an alkali hydroxide;
(b) precipitating impurity from the lithium sulfate stream;
(c) filtering impurity from the lithium sulfate stream; and
(d) adjusting the pH of the resulting stream to a pH of from 2 to 3.5 prior to feeding said stream into the bipolar electrodialysis apparatus.

34. The method of claim 16, further comprising
(a) recovering both the lithium hydroxide and sulfuric acid streams resulting from the bipolar electrodialysis;
(b) reacting the sulfuric acid stream with lithium carbonate to produce additional lithium sulfate solution;
(c) adding said additional lithium sulfate solution into the original feed stream contains lithium sulfate; and
(d) continuous feeding the lithium sulfate stream into the bipolar electrolysis apparatus.

35. The method of claim 34, further comprising steps of
(a) adjusting the lithium sulfate stream to a pH of from 10 and 11 to remove impurities by adding an alkali hydroxide;
(b) precipitating impurity from the lithium sulfate stream;
(c) filtering impurity from the lithium sulfate stream; and
(d) adjusting the pH of the resulting stream to a pH of from 2 to 3.5 prior to feeding said stream into the bipolar electrodialysis apparatus.

36. A bipolar electrodialysis apparatus for separating ionic species in a lithium sulfate containing stream by using a bipolar electrodialysis cell, wherein said bipolar electrodialysis cell comprises
(a) an anion permeable membrane, allowing the negatively charged sulfate ion to pass but hindering passage of the positively charged lithium ion;
(b) a cation permeable membrane, allowing the positively charged lithium ion to pass but hindering passage of the negatively sulfate charged ion;
(c) a bipolar membrane located between an anion permeable membrane and a cation permeable membrane, forming separate chambers with the anion permeable membrane and the cation permeable membrane respectively;
(d) an anode and a cathode, with said anion permeable membrane, cation permeable membrane and bipolar membrane positioned between said anode and said cathode; and
(e) a direct current applied across the electrodes.

37. The bipolar membrane of claim 36, wherein said bipolar membrane is formed from an anion-exchange layer and a cation-exchange layer, with said layers bound together.

38. The bipolar membrane of claim 37, further comprising a water diffusion layer or interface, allowing the water from the outer aqueous salt solution to diffuse.

39. The membranes of claim 36 are from commercially available sources.

40. The membranes of claim 39 are from commercially available sources, selected from the group consisting of Astom's ACM, CMB, AAV, BP, or FumaTech FKB.

41. The membranes of claim 36 are used in combination of their resistance to back migration of undesired ion, low electric resistivity and resistance to the potentially corrosive nature of the resultant acid and base solution.
